(19) United States
(12) Patent Application Publication
(10) Pub. No.: US 2023/0352867 A1
(43) Pub. Date: Nov. 2, 2023

(54) TERMINAL PLATING MATERIAL, TERMINAL CONNECTION STRUCTURE USING TERMINAL PLATING MATERIAL, AND SERVICE PLUG

(71) Applicant: Yazaki Corporation, Tokyo (JP)

(72) Inventors: Hiroshi FUJITA, Shizuoka (JP); Hideki MIZUNO, Shizuoka (JP); Yasuo YAMAUCHI, Shizuoka (JP); Satoka OHNISHI, Shizuoka (JP)

(73) Assignee: Yazaki Corporation, Tokyo (JP)

(21) Appl. No.: 18/140,950

(22) Filed: Apr. 28, 2023

(30) Foreign Application Priority Data
May 2, 2022 (JP) 2022-075829

(51) Int. Cl. H01R 13/03; H01R 13/46; H01B 1/02

(52) U.S. Cl. CPC H01R 13/03; H01R 13/46; H01B 1/02; H01B 1/026; H01B 1/04

(57) ABSTRACT

A terminal plating material includes a metallic base that contains copper or a copper alloy, and a carbon composite silver plating layer that disposed on the metallic base and contains either silver or a silver alloy and carbon.

### CROSS-REFERENCE TO RELATED APPLICATIONS

The present application is based on, and claims priority from the prior Japanese Patent Application No. 2022-075829, filed on May 2, 2022, the entire contents of which are incorporated herein by reference.

### TECHNICAL FIELD

The present disclosure relates to a terminal plating material, a terminal connection structure using the terminal plating material, and a service plug.

### BACKGROUND

As vehicle electrification advances, the number of electric and hybrid vehicles in which large-capacity batteries are mounted is increasing, and it is necessary to develop large-capacity small connectors to cope with the growing size of battery packs. Further, since electric and hybrid vehicles use high-power motors, large currents flow through wiring and terminals thereof, and the amount of heat generated is large. Thus, heat resistance performance is required for the terminals used in these vehicles.

Meanwhile, electric and hybrid vehicles have power supply circuit breakers, which are referred to as service plugs, for interrupting energization between the power supply and the load, in order to ensure operation safety during electrical system maintenance. Each power supply circuit breaker has two housings which are fitted to each other and a lever that is rotationally operated when the housings are attached to and detached from each other. JP2020-145040A discloses a service plug having good operability that is ensured by reducing the operating force required for fitting and detaching, and a clip terminal used for the service plug.

### SUMMARY

However, in a conventional service plug such as that disclosed in JP2020-145040A, it is necessary to increase the size and number of terminals to cope with a large current. Further, from the viewpoint of materials also, due to the increase in the terminal size, it is necessary to apply lubricant such as Klüber for suppressing terminal contact abrasion due to terminal insertion and removal and for maintaining high lever operability, and an increase in the manufacturing cost of plating used for terminals is a concern. Further, due to the above reasons, the heating temperature of the terminal contacts becomes high, and therefore, copper of a metallic base tends to diffuse easily to the outermost plating layer. Oxidation of the copper component precipitated on the plating surface causes an increase in contact resistance, which may reduce the electrical connection performance. In this way, the terminals used in electric and hybrid vehicles have issues to be solved such as the enhancement of contact reliability and the reduction of manufacturing cost.

The present disclosure has been devised in view of the above-mentioned problem in the related art. An object of the present disclosure is to provide a terminal plating material with enhanced abrasion resistance and conductivity, and a terminal connection structure using the terminal plating material, and a service plug.

A terminal plating material according to an embodiment includes a metallic base that contains copper or a copper alloy, and a carbon composite silver plating layer that is disposed on the metallic base and contains either silver or a silver alloy and carbon.

A terminal connection structure according to an embodiment has a female terminal and a male terminal to be fitted to the female terminal, and at least one of the female terminal or the male terminal has the terminal plating material.

A service plug according to an embodiment includes the terminal connection structure.

According to the present disclosure, it is possible to provide a terminal plating material with enhanced abrasion resistance and conductivity, a terminal connection structure using the terminal plating material, and a service plug.

### BRIEF DESCRIPTION OF THE DRAWINGS

FIG. 1A is a cross-sectional view illustrating an example of a terminal plating material according to the present embodiment.

FIG. 1B is a cross-sectional view illustrating an example of a terminal plating material according to the present embodiment.

FIG. 2A is a cross-sectional view illustrating the state of a conventional terminal plating material (a silver-antimony plating layer) before heating.

FIG. 2B is a cross-sectional view illustrating the state of a conventional terminal plating material during heating.

FIG. 2C is a cross-sectional view of a conventional terminal plating material after heating.

FIG. 3A is a cross-sectional view of a terminal plating material according to the present embodiment before heating.

FIG. 3B is a cross-sectional view of a terminal plating material according to the present embodiment during heating.

FIG. 3C is a cross-sectional view of a terminal plating material according to the present embodiment after heating.

FIG. 4A is a plan view illustrating the state of the outermost surface of a conventional terminal plating material (a silver-antimony plating layer) after heating.

FIG. 4B is an enlarged view of a cross section taken along line A-A of the conventional terminal plating material illustrated in FIG. 4A and a contact portion of a contact of an evaluation device.

FIG. 5A is a plan view illustrating the state of the outermost surface of the terminal plating material according to the present embodiment after heating.

FIG. 5B is an enlarged view of a cross section taken along line B-B of the terminal plating material according to the present embodiment illustrated in FIG. 5A and a contact portion of a contact of an evaluation device.

FIG. 6A is a schematic view illustrating an example (ten contact points) of a connection state between female terminals and a male terminal of a terminal connection structure according to the present embodiment.

FIG. 6B is a schematic view illustrating an example (four contact points) of a connection state between female terminals and a male terminal of a terminal connection structure according to the present embodiment.

FIG. 7 is a graph illustrating measurement results of a contact load and contact resistance before and after heating for a terminal plating material according to the present embodiment.

FIG. 8 is a graph illustrating analysis results of a state in which copper (Cu) precipitates on a surface of a silver plating layer after heating, by means of X-ray photoelectron spectroscopy (XPS) for a terminal plating material according to the present embodiment.

FIG. 9 is a graph illustrating results of a friction coefficient evaluation for a terminal plating material according to the present embodiment.

FIG. 10 is a cross-sectional view illustrating an evaluation method of a contact resistance value and abrasion resistance.

FIG. 11 is a diagram illustrating results of an abrasion resistance evaluation for a terminal plating material according to the present embodiment.

### DETAILED DESCRIPTION

A detailed description will be given with reference to the drawings regarding a terminal plating material, a terminal connection structure using the terminal plating material, and a service plug according to the present embodiment. Note that the dimensional ratios in the drawings are exaggerated for convenience of the explanation and may differ from the actual ratios.

### Terminal Plating Material 1

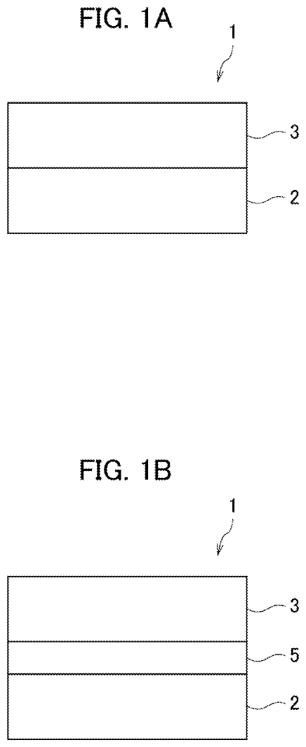

As illustrated in FIG. 1A, a terminal plating material 1 of the present embodiment includes a metallic base 2 containing copper or a copper alloy, and a carbon composite silver plating layer 3 disposed on the metallic base 2. Details of each configuration of the present embodiment will be described below.

### Metallic Base 2

The metallic base 2 is a material to be plated on the carbon composite silver plating layer 3 or an underlayer 5 which will be described later. The metallic base 2 contains copper or a copper alloy. As the copper or copper alloy used for the metallic base 2, those specified in the Japanese Industrial Standards JIS H3100 (Copper and copper alloy sheets, plates and strips) can be used, for example. Specifically, the following can be used: anoxic copper (C1020), tough pitch copper (C1100), phosphorous deoxidized copper (C1201), tin-containing copper (C1441), zirconium-containing copper (C1510), iron-containing copper (C1921), and the like.

Further, as the material properties of the metallic base 2, the metallic base 2 may contain metals and compounds other than copper and copper alloy. Examples of metals and compounds other than copper and copper alloy include one or more elements selected from the group consisting of Ni, Co, Fe, Pt, Au, Al, Si, Cr, Mg, Mn, Mo, Rh, Ta, Ti, W, U, V, and Zr, or compounds containing the above one or more elements. The specific shape of the metallic base 2 is not particularly limited and the metallic base 2 may be shaped according to the application.

### Carbon Composite Silver Plating Layer 3

The carbon composite silver plating layer 3 is disposed on the metallic base 2 as illustrated in FIG. 1A. The carbon composite silver plating layer 3 contains either silver or a silver alloy and further contains carbon. The carbon composite silver plating layer 3 causes the copper diffused from the metallic base 2 to remain, and has a role of suppressing the surface precipitation of copper. Therefore, according to the terminal plating material 1 of the present embodiment, it is possible to enhance the heat resistance of silver plating by suppressing the surface precipitation of copper of the metallic base 2 after heat generation. From the viewpoint of suppressing the surface precipitation of copper, it is preferable that the carbon composite silver plating layer 3 covers the entire metallic base 2. Further, as illustrated in FIG. 1B, the carbon composite silver plating layer 3 may indirectly cover the metallic base 2 with the underlayer 5 described later therebetween.

In general, if heat is added, the thermal vibration of the copper atoms of the metallic base becomes intense, and it becomes possible to change the position thereof. Then, some of the copper atoms of the metallic base diffuse into the grain boundaries of the plating layer disposed on the metallic base. Further, the copper atoms that have diffused into the grain boundaries of the plating layer move to the plating surface for stability in terms of energy. This causes the copper diffused from the metallic base to be precipitated on the surface of the plating and oxidized, and accordingly the contact resistance increases.

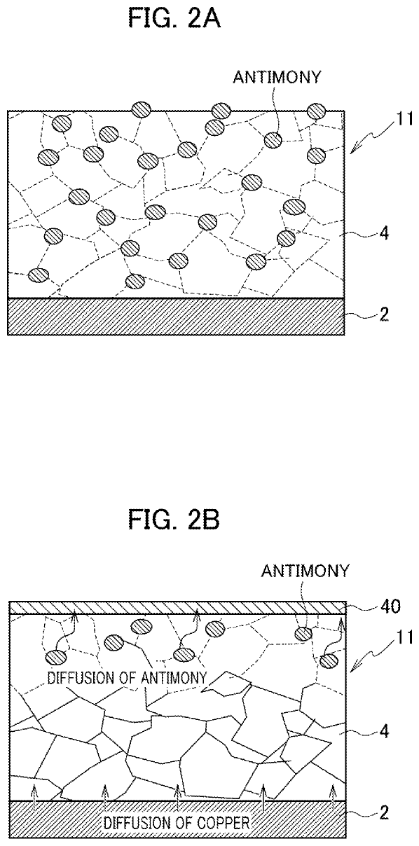

As a conventional terminal plating material 11, a terminal plating material in which a silver-antimony plating layer 4 is disposed on the metallic base 2 is heated at 190° C. for 500 hours, for example. This changes the state from the state in FIG. 2A (before heating) to the state in FIG. 2B (during heating), and then to the state in FIG. 2C (after heating). First, in FIG. 2A of the state before heating, antimony exists in the silver-antimony plating layer 4. Then, in the state during heating, copper diffused from the metallic base 2 diffuses into the grain boundaries of the silver-antimony plating layer 4 as illustrated in FIG. 2B. Further, in the state during heating, antimony in the silver-antimony plating layer 4 diffuses toward the surface, precipitates on the surface of the silver-antimony plating layer 4, and forms a layer of oxidized antimony (hereinafter referred to as an antimony oxide 40). In the state after heating, copper precipitates on the surface of the layer of the antimony oxide 40 and forms a layer of oxidized copper (hereinafter referred to as copper oxide 20) as illustrated in FIG. 2C. In this way, copper diffused from the metallic base precipitates on the surface of the plating and forms a layer of the copper oxide 20. Accordingly, the contact resistance value increases in a high-temperature environment.

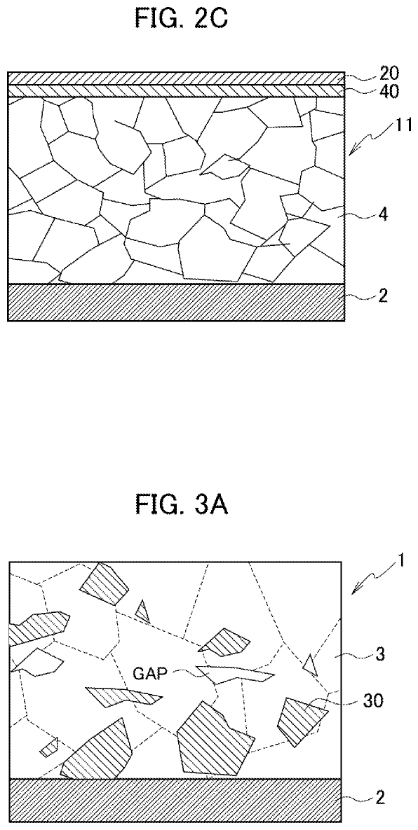

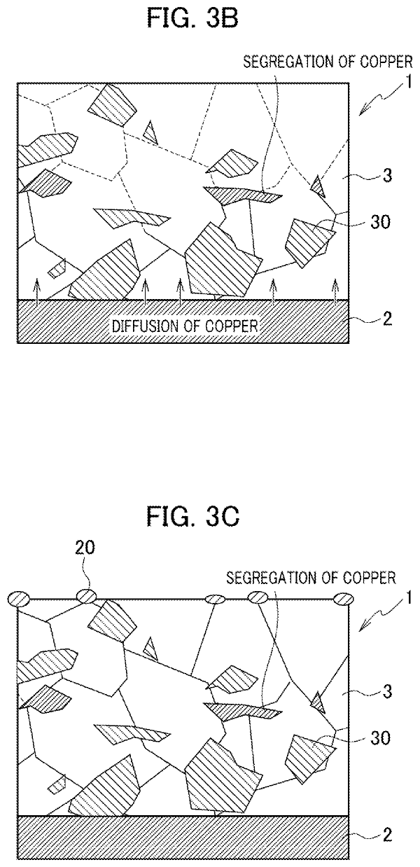

Meanwhile, if the terminal plating material 1 of the present embodiment is heated at 190° C. for 500 hours, the state changes from the state illustrated in FIG. 3A (before heating) to the state illustrated in FIG. 3B (during heating), and then to the state illustrated in FIG. 3C (after heating). First, in FIG. 3A of the state before heating, carbon 30 and gaps exist in the carbon composite silver plating layer 3. Then, in the state during heating, copper diffused from the metallic base 2 diffuses into the grain boundaries of the carbon composite silver plating layer 3 as illustrated in FIG. 3B. At that time, the diffused copper easily binds with oxygen that is present in the gaps in the carbon composite silver plating layer 3, and therefore copper remains and segregates in the gaps. Therefore, in the state after heating, some copper remains in the carbon composite silver plating layer 3 as illustrated in FIG. 3C. This can suppress the precipitation of copper on the surface of the carbon composite silver plating layer 3, that is, the formation of a layer of the copper oxide 20 as illustrated in FIG. 2C. In this way, by suppressing the surface precipitation of copper of the metallic base 2 after heat generation, it becomes possible to minimize an increase in the contact resistance value in a high-temperature environment.

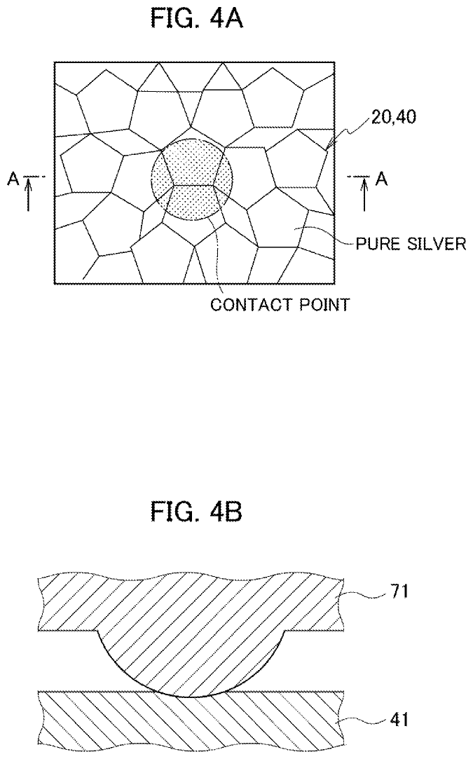

FIG. 4A is a plan view illustrating the state of the conventional terminal plating material 11 (the silver-antimony plating layer) after heating. On the surface of the conventional terminal plating material, pure silver is surrounded by the copper oxide 20 and/or the antimony oxide 40. FIG. 4B is a cross-sectional view illustrating a state in which a contact 71 of an evaluation device used for measuring the contact resistance value is in contact with an outermost layer 41 of the conventional terminal plating material. The contact 71 has a hemispherical protrusion part as a contact part. The area in the dotted line illustrated in the center of FIG. 4A illustrates the contact point between the contact 71 and the outermost layer 41 of the conventional terminal plating material.

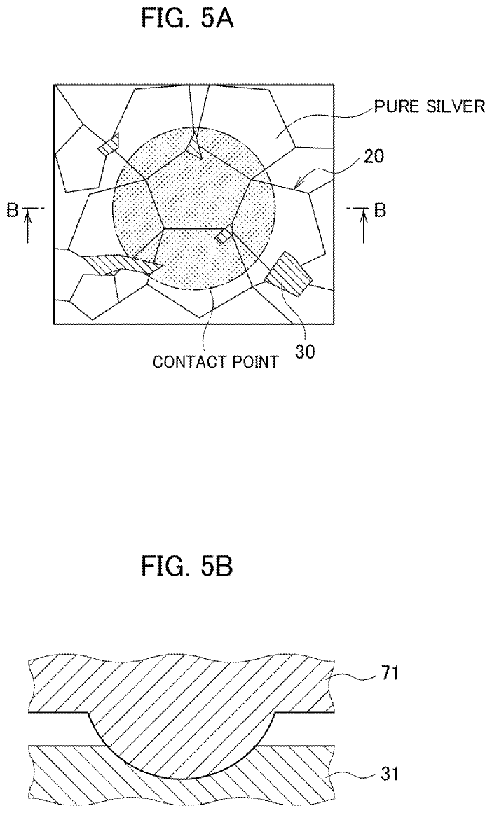

Meanwhile, FIG. 5A is a plan view illustrating the state of the terminal plating material 1 of the present embodiment after heating. Pure silver is surrounded by the copper oxide 20 on the surface of the terminal plating material. Further, FIG. 5B is a cross-sectional view illustrating a state in which the contact 71 of the evaluation device used for measuring the contact resistance value is in contact with the outermost layer 31 of the terminal plating material. The contact 71 has a hemispherical protrusion part as a contact part. The area in the dotted line illustrated in the center of FIG. 5A illustrates the contact point between the contact 71 and the outermost layer 31 of the terminal plating material.

Comparing the contact points between the contact 71 and the outermost layers of the individual plating materials, it can be seen that the terminal plating material 1 of the present embodiment has less oxide, which is an energization inhibiting factor, and a greater area occupied by pure silver, that is, a greater number of energization paths, than the conventional terminal plating material 11. This makes it possible to minimize an increase in the contact resistance value in a high-temperature environment.

Further, the outermost layer 41 of the conventional terminal plating material has a large amount of oxide, and therefore the Vickers hardness of the outermost layer after heating is 130 Hv while the Vickers hardness before heating is 180 Hv. Meanwhile, the outermost layer 31 of the terminal plating material of the present embodiment has a large amount of pure silver, and therefore the Vickers hardness of the outermost layer is 80 Hv before and after heating. In this way, the outermost layer 31 of the terminal plating material is softer than the outermost layer 41 of the conventional terminal plating material even after heating, and therefore the contact area with the contact 71 is large as illustrated in FIG. 5B. This makes it possible to minimize an increase in the contact resistance value in a high-temperature environment. The Vickers hardness can be measured according to the Japanese Industrial Standards JIS Z2244: 2009 (Vickers hardness test—Test method).

When the terminal plating material 1 of the present embodiment is used as a terminal, due to the inclusion of the carbon 30 in the carbon composite silver plating layer 3, the carbon 30 breaks during sliding of the layer, the layer acts as a lubricating film and becomes slippery, and accordingly the insertion force is reduced. In addition, since the contact pressure at the contact part of the terminal becomes small, the carbon composite silver plating layer 3 is not easily scraped even if the terminal is repeatedly inserted and removed. Therefore, the terminal plating material 1 is also excellent in abrasion resistance.

The carbon composite silver plating layer 3 is preferably pure silver plating containing the carbon 30. If the layer is pure silver plating, gaps are easily formed in the carbon composite silver plating layer 3 during plating formation. Therefore, copper easily remains and segregates in the gaps, and surface precipitation of copper diffused from the metallic base 2 is easily suppressed.

The carbon composite silver plating layer 3 can be formed by dispersing the carbon material in a silver plating bath and immersing the metallic base 2 in the silver plating bath to perform plating. In this case, in order to disperse the carbon material efficiently, it is preferable that before adding the carbon material to the silver plating bath, an oxide layer is removed in advance by means of a general method of removing oxide layers (for example, treatment with acids, alkalis, or organic solvents) and washing with water is performed. Further, the method of dispersing the carbon material in the silver plating bath is not particularly limited, and the carbon material can be dispersed by stirring at high speed after adding the carbon material to the silver plating bath. In order to disperse the carbon material efficiently, an external force may be applied by using an ultrasonic disperser or the like after adding the carbon material to the silver plating bath. By performing such processes, the carbon material unravels easily.

Examples of the carbon material added to the carbon composite silver plating layer 3 include graphite, graphene, carbon fibers, carbon nanotube, carbon nanohorn, carbon nanofibers, carbon black, fullerene, or the like. From the viewpoint of making it easier to segregate copper in the gaps in the carbon composite silver plating layer 3, the carbon material added to the carbon composite silver plating layer 3 is preferably graphite.

For the carbon composite silver plating layer 3, it is possible to use an alloy containing metal and silver of at least one or more selected from the group consisting of tin (Sn), copper (Cu), nickel (Ni), cobalt (Co), palladium (Pd), bismuth (Bi), indium (In), antimony (Sb), selenium (Se), and tellurium (Te). These silver alloys are known to have smaller grains and larger Vickers hardness values compared with pure silver. The silver alloy may be a binary alloy containing metal of two components, a ternary alloy containing metal of three components, or an alloy containing metal of four or more components. The carbon composite silver plating layer 3 may be a single layer or multiple layers.

In addition to the carbon material, the silver plating bath used to form the carbon composite silver plating layer 3 may have silver salts, salts of the above described metals, conducting salts, luster agents, and the like, for example. The material used for silver salts contains salts of at least one or more selected from the group consisting of silver cyanide, silver iodide, silver oxide, silver sulfate, silver nitrate, silver methanesulfonate, and silver chloride, for example. Further, the conducting salts include salts of at least one or more selected from the group consisting of potassium cyanide, sodium cyanide, potassium pyrophosphate, silver methanesulfonate, potassium iodide, and sodium thiosulfate. Examples of the luster agent include metal luster agents such as antimony, selenium, and tellurium, and organic luster agents such as benzenesulfonic acid and mercaptan. The silver ion concentration of the silver plating bath is preferably 30 g/L to 50 g/L, for example.

The plating treatment for forming the carbon composite silver plating layer 3 is preferably constant current electrolysis because the film thickness can be easily controlled. The conditions for performing electrolytic plating on the carbon composite silver plating layer 3 are not particularly limited and the layer can be plated by means of a known plating method. The current density can be set considering various factors such as productivity, plating bath composition, ion concentration, and shape of the object to be plated. Further, the plating bath temperature is not particularly limited.

From the viewpoints of suppressing the diffusion of copper in the metallic base after heat generation and the surface precipitation of copper, the thickness of the carbon composite silver plating layer 3 is preferably 3 μm or more.

### Underlayer 5

As illustrated in FIG. 1B, the terminal plating material 1 of the present embodiment may further include the underlayer 5 to impart various functions. In the present embodiment, the underlayer 5 is interposed between the metallic base 2 and the carbon composite silver plating layer 3.

The underlayer 5 preferably contains metal of at least one or more selected from the group consisting of nickel, copper, and silver. Specifically, the underlayer 5 preferably contains metal of at least one or more selected from the group consisting of nickel, a nickel alloy, copper, a copper alloy, silver, and a silver alloy.

The underlayer 5 more preferably contains nickel or a nickel alloy. If the underlayer 5 contains nickel or a nickel alloy, the underlayer 5 can suppress the diffusion of copper from the metallic base 2 to the carbon composite silver plating layer 3 and enhance the contact reliability and heat resistance, for example. That is, the underlayer 5 functions as a barrier layer. If the underlayer 5 contains either nickel or a nickel alloy, the layer thickness is preferably more than 0.5 μm and 1 μm or less, but the layer thickness is not particularly limited if the layer functions as a barrier layer.

If the underlayer 5 contains metal of at least one or more selected from the group consisting of copper, a copper alloy, silver, and a silver alloy, it is possible to enhance the adhesion between the metallic base 2 and the carbon composite silver plating layer 3, for example. That is, the underlayer 5 functions as a strike plating layer. When the underlayer 5 contains metal of at least one or more selected from the group consisting of copper, a copper alloy, silver, and a silver alloy, the layer thickness is not particularly limited if the adhesion is enhanced, and even if the layer is very thin, the adhesion may be enhanced.

The underlayer 5 may be a single layer or multiple layers. The underlayer 5 may include a lower layer and an upper layer disposed on the lower layer, for example. The lower layer of the underlayer 5 may contain either nickel or a nickel alloy, and the upper layer of the underlayer 5 may include metal of at least one or more selected from the group consisting of copper, a copper alloy, silver, and a silver alloy, for example. Therefore, a nickel plating layer may be formed as the lower layer of the underlayer 5 and a silver strike plating layer may be formed as the upper layer of the underlayer 5, for example. The combination of these layers may be changed appropriately according to the purpose.

The method of forming the underlayer 5 is not particularly limited, but the material to be plated of the metallic base 2 can be placed in a plating bath and plating can be performed by means of a known plating method, for example.

The contact resistance value of the terminal plating material 1 of the present embodiment is preferably 0 mΩ or more and 1.5 mΩ or less. By setting the contact resistance value of the terminal plating material 1 in such a range, heat generation and power consumption can be reduced when the terminal plating material 1 is used as a terminal. The contact resistance value of the terminal plating material 1 is more preferably 0 mΩ or more and 1.0 mΩ or less, and even more preferably 0 mΩ or more and 0.5 mΩ or less.

From the viewpoint of heat resistance, after heating the terminal plating material 1 at 190° C. for 500 hours, the contact resistance value of the terminal plating material 1 is preferably 1.0 mΩ or less when a contact load of 10 N is applied by using a contact having a hemispherical protrusion part with a radius of 1 mm as a contact part. Further, from the viewpoint of heat resistance, the contact resistance value of the terminal plating material 1 is more preferably 0.5 mΩ or less.

In this way, the terminal plating material 1 of the present embodiment has the metallic base 2 containing copper or a copper alloy and the carbon composite silver plating layer 3 which is disposed on the metallic base 2 and contains either silver or a silver alloy and the carbon 30. Therefore, the terminal plating material 1 can enhance the abrasion resistance and conductivity by suppressing the surface precipitation of copper of the metallic base after heat generation.

### Terminal Connection Structure

A terminal connection structure according to the present embodiment has a female terminal 50 and a male terminal 60 to be fitted to the female terminal 50. At least one of the female terminal 50 or the male terminal 60 includes the terminal plating material 1 having the carbon composite silver plating layer 3. Therefore, the female terminal 50 and the male terminal 60 of the present embodiment have higher abrasion resistance while minimizing an increase in the contact resistance value in a high-temperature environment, compared with a terminal having conventional silver or silver alloy plating.

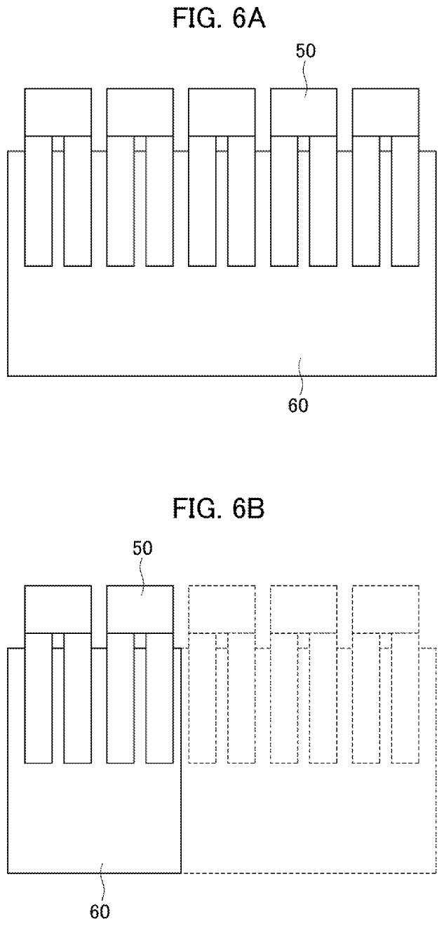

The terminal plating material 1 has excellent abrasion resistance and conductivity. Therefore, it is preferable that in a connector terminal that is repeatedly inserted and removed, the female terminal is used as a clip terminal and the male terminal is used as a plate-like terminal to be fitted to the clip terminal, for example. FIGS. 6A and 6B illustrate an example of a terminal connection structure according to the present embodiment, and the structure has a plurality of female terminals 50 and a male terminal 60 that is electrically connected to the female terminals 50. In FIGS. 6A and 6B, the female terminals 50 are illustrated as clip terminals and the male terminal 60 is illustrated as a plate-like terminal to be fitted to the clip terminals. The number of contacts is four in FIG. 6B, while the number of contacts is ten in FIG. 6A. The female terminals 50 and the male terminal 60 are housed in their respective connector housings (not shown) in a positioned state, and when both connector housings are fitted together, the female terminals 50 and the male terminal 60 are fitted together.

If the male terminal 60 is a plate-like terminal, it is preferable to perform a plating treatment by means of a rack method in which the material to be plated is hung on a hanging rack and plated, from the viewpoint of the size and shape of the material to be plated and the size of the surface area of the part to be plated. Further, if the female terminals 50 are clip terminals, from a similar viewpoint, it is preferable to perform a plating treatment by means of a barrel method in which the material to be plated is placed in a barrel and plated while being rotated.

Meanwhile, if the terminal plating material 1 is applied to at least one of the female terminal 50 or the male terminal 60, it is preferable to adopt the rack method from the viewpoint of the stability of the plating treatment for forming the carbon composite silver plating layer 3. Therefore, it is preferable that the male terminal 60 has the terminal plating material 1. In addition, if the male terminal 60 has the terminal plating material 1, it is preferable that the female terminal 50 has a metallic base containing copper or a copper alloy and a silver plating layer which is disposed on the metallic base and contains either silver or a silver alloy from the viewpoint of corrosion prevention and conductivity.

The silver plating layer used for the female terminal 50 has the role of preventing corrosion and imparting conductivity, and therefore it is preferable that the silver plating layer covers the entire metallic base. Further, the silver plating layer used for the female terminal 50 may indirectly cover the metallic base with the underlayer formed by means of the above method therebetween.

The silver plating layer used for the female terminal 50 can be formed by immersing the metallic base in a silver plating bath and performing plating, similar to the method for producing the carbon composite silver plating layer 3 described above. The silver plating bath can contain silver salts, metal salts, conducting salts, luster agents, and the like, similar to the method for producing the carbon composite silver plating layer 3 described above, for example. Further, the plating treatment for forming the silver plating layer is preferably constant current electrolysis because the film thickness can be easily controlled. The current density when electrolytic plating is performed can be set considering various factors such as the productivity, plating bath composition, ion concentration, and shape of the object to be plated. Moreover, the plating bath temperature is not particularly limited.

It is more preferable that the silver plating layer used for the female terminal 50 contain antimony from the viewpoint of abrasion resistance. That is, the female terminal 50 preferably has a metallic base containing copper or a copper alloy, and a silver-antimony plating layer which is disposed on the metallic base and contains either silver or a silver alloy and antimony. The amount of antimony contained in the silver-antimony plating layer is preferably 1% by mass or more and 2% by mass or less. Further, from the viewpoint of the abrasion resistance, the thickness of the silver-antimony plating layer is preferably more than 5 μm and 10 μm or less.

Generally, if a large current flows through the terminal, the contact resistance increases, the terminal contacts tend to heat up and melt, and accordingly welding easily occurs. However, as described above, the terminal plating material 1 has excellent abrasion resistance and conductivity. Therefore, in the terminal connection structure according to the present embodiment, welding caused by an increase in contact resistance is less likely to occur even if a large current flows due to suppressing of the number and size of the terminals. Therefore, it is possible to suppress the number and size of the terminals. Further, the terminal plating material 1 has excellent abrasion resistance and conductivity. This leads to the elimination of a process for applying a lubricant such as Klüber, the reduction of plating material costs by reducing the plating coverage area, and the enhancement of the contact reliability.

In this way, the terminal connection structure according to the present embodiment includes the female terminal 50 and the male terminal 60 to be fitted to the female terminal 50. At least one of the female terminal 50 or the male terminal 60 has the terminal plating material 1. Therefore, the terminal connection structure can enhance the abrasion resistance and conductivity.

### Service Plug

A service plug of the present embodiment has a terminal connection structure. The service plug is used as a power supply circuit breaker for safely inspecting and maintaining parts where a large current and high voltage flow such as a controller, battery, and motor of a hybrid or electric vehicle. The terminal connection structure of the present embodiment has higher abrasion resistance of the terminal part, can minimize an increase in the contact resistance in a high-temperature environment, and enhances the contact reliability compared to the case where a terminal with conventional silver or silver alloy plating is used. Therefore, it is not necessary to increase the size of the terminal or the number of terminals to cope with a large current, and the plating material cost can be reduced by reducing the plating coverage area. In addition, it is possible to eliminate a process for applying a lubricant such as Klüber for suppressing the abrasion of the terminal contacts due to terminal insertion and removal and for maintaining high lever operability. Therefore, the service plug of the present embodiment can be suitably used in any location of a hybrid or electric vehicle.

The terminal plating material, the terminal connection structure, and the service plug using the terminal connection structure according to the present embodiment have been described, but they are not limited to the above embodiment. The terminal plating material has excellent abrasion resistance and conductivity, and therefore the terminal plating material can be suitably used as a connector terminal that can be inserted and removed repeatedly in electronic equipment, in-vehicle and electrical components, transmissions, and wire harnesses for devices, relays, sensors, and the like, for example. In addition, as described above, the connector can be made smaller and lighter because the contact reliability is enhanced compared with the conventional connector terminal.

### EXAMPLES

The present disclosure will be described in more detail below by using examples and comparative examples, but the present disclosure is not limited to these examples.

First, the metallic base, which is the material to be plated, was pretreated. Specifically, the metallic base was washed by alkaline degreasing, pickled by soaking the base in 10% sulfuric acid for 1 minute, and then the base was washed with water. The metallic base used was NB-109EH (manufactured by DOWA METALTECH CO., LTD.), which is a copper alloy.

Next, a nickel plating layer was formed on the metallic base. The nickel plating layer is an underlayer. Specifically, the metallic base pretreated as described above was immersed in a plating bath for the nickel plating layer, and constant current electrolysis was performed using a DC stabilized power supply. After the end of the electrolysis, the metallic base was removed from the silver plating bath and washed with water. As a result, the nickel plating layer is formed on the entire surface of the metallic base. The thickness of the nickel plating layer was 1.0 μm.

Further, the carbon composite silver plating layer was formed on the nickel plating layer. Specifically, graphite that was washed with water after removing the oxide layer of graphite in advance was prepared and, and the graphite was dispersed in a silver plating bath for the pure silver plating layer. Then, the metallic base on which the nickel plating layer was formed was immersed in the silver plating bath and constant current electrolysis was performed by using a DC stabilized power supply. After the end of the electrolysis, the metallic base was removed from the plating bath and washed with water. As a result, the nickel plating layer and the carbon composite silver plating layer were formed on the entire surface of the metallic base. The thickness of the carbon composite silver plating layer was set at 5 to 10 μm as a target value. This was used as the sample in Examples 1 to 6.

Meanwhile, as a comparative example, a sample was prepared by forming the underlayer (the nickel plating layer) and the silver plating layer (the silver-antimony plating layer) on the metallic base, based on the test sample preparation method described above. Specifically, the metallic base on which the nickel plating layer was formed as described above, was immersed in the silver plating bath for the silver-antimony plating layer and constant current electrolysis was performed by using the DC stabilized power supply. After the end of the electrolysis, the metallic base was removed from the silver plating bath and washed with water. As a result, the nickel plating layer and the silver-antimony plating layer were formed on the entire surface of the metallic base. The thickness of the silver-antimony plating layer was set at 5 to 10 μm as a target value. This was used as a sample in Comparative Examples 1 to 6.

### Evaluation

Using the terminal plating material prepared as described above as a test sample, evaluations were performed by means of the following methods.

### Contact Resistance Value Evaluation

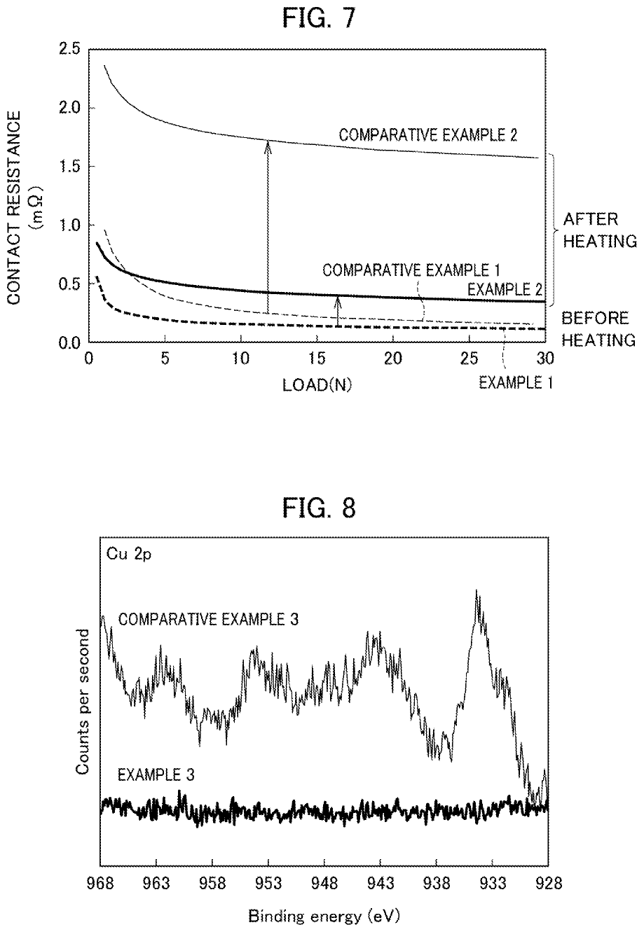

An electric contact simulator (manufactured by Yamasaki-Seiki Co., Ltd.) was used to perform a contact load-contact resistance property evaluation. Specifically, as illustrated in FIG. 10, a plate 10 with a thickness of 5 μm, which is a test sample, was fixed on a stage 72, and a contact 71 was brought into contact with the plate 10. The contact 71 had a hemispherical protrusion part with a radius of 1 mm as a contact part, and the projection height of the contact 71 was 0.5 mm. Then, the contact resistance value (mΩ) at contact loads of 1N to 30N was measured for the surface of the carbon composite silver plating layer before heating (Example 1) and after heating (Example 2). The results are illustrated in FIG. 7. The heating conditions in Example 2 were set at 190° C. for 500 hours.

As illustrated in Example 1 and Example 2 in FIG. 7, across the entire range of the contact loads, it was confirmed that the contact resistance value increased after heating. This indicates that copper of the metallic base precipitated on the surface of the carbon composite silver plating layer due to heating, the copper component was oxidized, and accordingly the contact resistance value was increased. It was also confirmed in Example 2 that the contact resistance value was 1.0 mΩ or less when a contact load of 10 N was applied by using the above contact 71 after heating at 190° C. for 500 hours.

Meanwhile, as a comparative example, the contact resistance value (mΩ) was measured for the surface of the silver-antimony plating layer before heating (Comparative Example 1) and after heating (Comparative Example 2). The heating conditions in Comparative Example 2 were the same as those in Example 2.

As illustrated in Comparative Example 1 and Comparative Example 2 in FIG. 7, it was confirmed that the contact resistance value increased after heating across the entire range of the contact loads. This indicates that, as in Examples 1 and 2, copper of the metallic base precipitated on the surface of the silver-antimony plating layer due to heating, the copper component was oxidized, and accordingly the contact resistance value was increased. It was also confirmed in Comparative Example 2 that the contact resistance value was more than 1.5 mΩ when a contact load of 10 N was applied by using the above contact 71 after heating at 190° C. for 500 hours and that the value was increased significantly compared to the value in Example 2.

Comparing Example 1 with Comparative Example 1, in all ranges of contact loads, a contact resistance value in Example 1 is lower than that in Comparative Example 1. Further, comparing Example 2 with Comparative Example 2, in all ranges of contact loads, a contact resistance value is lower in Example 2 than that in Comparative Example 2. Moreover, the tendency is more remarkable in Example 2 and Comparative Example 2 after heating. From the above, in the terminal plating material according to the present embodiment, it is revealed that the increase in the contact resistance value can be minimized by suppressing the surface precipitation of copper of the metallic base after heating.

### Evaluation of Surface Precipitation of Copper

The state in which copper (Cu) is precipitated on the surface of the plating layer after heating was analyzed by means of the X-ray photoelectron spectroscopy (XPS). Specifically, FIG. 8 illustrates the results of analyzing the surface of the carbon composite silver plating layer (Example 3) and the surface of the silver-antimony plating layer (Comparative example 3) after heating at 190° C. for 500 hours.

As illustrated in FIG. 8, in Comparative Example 3, there are multiple peaks derived from copper or copper oxide between 935 eV and 968 eV of the binding energy. However, in Example 3, copper or copper oxide peaks were hardly observed. That is, it was confirmed that while in Comparative example 3 copper was precipitated on the surface of the silver-antimony plating layer, in Example 3 copper was hardly precipitated on the surface of the carbon composite silver plating layer. This reveals that the terminal plating material according to the present embodiment suppresses the surface precipitation of copper of the metallic base after heating.

### Evaluation of Friction Coefficient

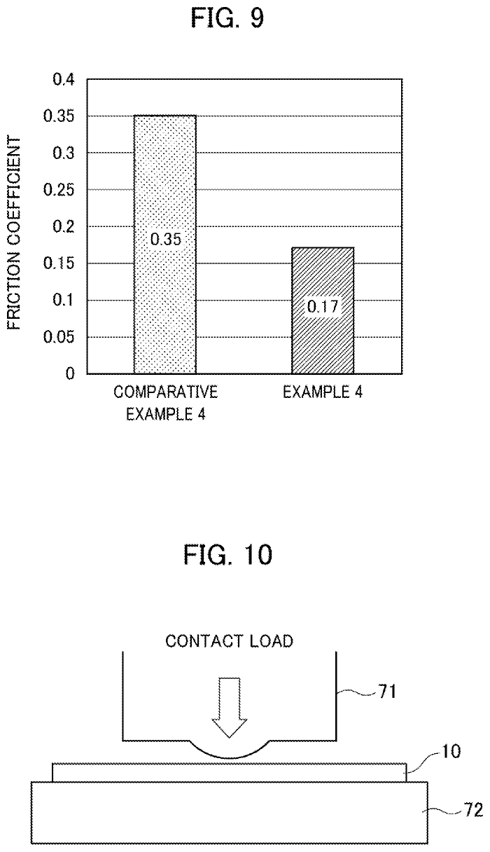

In order to evaluate the insertion force when the terminal plating material is used for the terminal, the friction coefficient of the terminal plating material was measured by using a horizontal load measuring instrument (manufactured by Yamasaki-Seiki Co., Ltd.). Specifically, a test sample was fixed on a horizontal platform of the horizontal load measuring instrument, and the same contact 71 used in the contact resistance value evaluation was brought into contact with the test sample. Then, while pressing the contact against the surface of the plating layer with a contact load of 2 N, the plating layer was pulled by a sliding distance of 8 mm in the horizontal direction at a sliding speed of 3 mm/second, the force applied horizontally to the measuring distance of 8 mm was measured, and an average value F was calculated. Then, the dynamic friction coefficient μ was calculated by dividing the average value F by the load of 2 N. FIG. 9 illustrates the evaluation results for the surface of the carbon composite silver plating layer (Example 4) and the surface of the silver-antimony plating layer (Comparative Example 4) after heating at 190° C. for 500 hours. As a result, the dynamic friction coefficient μ was 0.17 in Example 4 and 0.35 in Comparative Example 4. This indicates that the friction coefficient of the surface of the carbon composite silver plating layer is significantly smaller than that of the surface of the silver-antimony plating layer even after heating. It is also revealed that the terminal plating material according to the present embodiment has excellent abrasion resistance and low insertion force when the terminal plating material is used for the terminal.

### Evaluation of Abrasion Resistance by Sliding Test

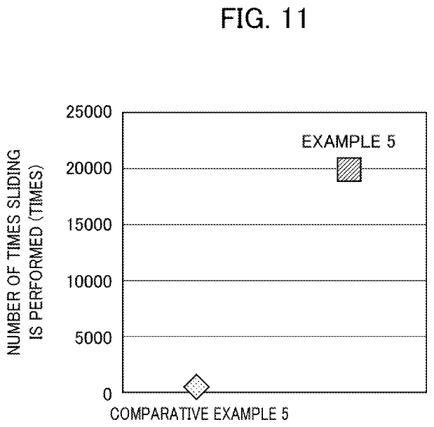

The evaluation of the abrasion resistance was performed by means of a sliding test using a sliding test machine (manufactured by Yamasaki-Seiki Co., Ltd.). Specifically, as illustrated in FIG. 10, the plate 10 with a thickness of 5 μm, which is a test sample, was fixed on the stage 72, and the same contact 71 used in the contact resistance value evaluation was brought into contact with the plate 10. The test was performed under conditions that the projection height of the contact 71 was 0.5 mm, the sliding distance was 10 mm, the sliding speed was 3 mm/second, and the contact load was 2 N. For the determination in the sliding test, an evaluation was carried out according to the number of times that sliding was preformed until the copper of the metallic base was exposed, and the maximum number of times that sliding was performed was set to be 20,000. FIG. 11 illustrates the results of an evaluation for the surface of the carbon composite silver plating layer (Example 5) and the surface of the silver-antimony plating layer (Comparative Example 5) after heating at 190° C. for 500 hours. As a result, in Example 5, copper in the metallic base was not exposed even after performing sliding 20,000 times, while in Comparative Example 5, exposure of copper in the metallic base was observed after performing sliding 370 times. That is, the number times that sliding was performed until copper in the metallic base was exposed for the carbon composite silver plating layer was 50 times or more compared with the number of times that sliding was performed for the silver-antimony plating layer. This indicates that the carbon composite silver plating layer has excellent abrasion resistance and low insertion force when used for the terminal even after heating compared with the silver-antimony plating layer.

### Evaluation of Effect of Decreasing the Number of Terminals

The effect on the welding of terminals by decreasing the number of terminals was evaluated. Specifically, a terminal connection structure was assumed which has multiple female terminals and a male terminal electrically connected to the female terminals, and the effect on the welding was evaluated when the number of terminals in the state of FIG. 6A is decreased to the number of terminals in the state in FIG. 6B, that is when the number of contact points is decreased from ten to four. The evaluation was performed by using silver-antimony plating for the plating layers of the female terminals and using carbon composite silver plating (Example 6), hard carbon composite silver plating (Example 7), or silver-antimony plating (Comparative example 6) for the plating layer of the male terminal. The results are shown in Table 1. The hard carbon composite silver plating in Example 7 is the plating formed by adding an organic substance to the silver plating bath used to form the carbon composite silver plating layer and hardening it in the above test sample preparation method.

First, by using an electric contact simulator (manufactured by Yamasaki-Seiki Co., Ltd.), energization was performed with a direct current of 10 A, and the contact resistance value at a contact load of 2 N was obtained. Specifically, as illustrated in FIG. 10, the plate 10 with a thickness of 5 μm, which is a test sample, was fixed on the stage 72, and the same contact 71 used in the contact resistance value evaluation was brought into contact with the plate 10. The measurement was performed under the conditions that the projection height of the contact 71 was set at 0.5 mm and the contact load was 2 N. Table 1 shows the results of measuring the contact resistance values (mΩ) before and after heating for Example 6, Example 7, and Comparative example 6. The heating conditions were set as a temperature of 190° C. and a time of 500 hours.

As the number of contact points decreases, the energizing current flowing per contact point (A) becomes larger. As a calculation condition, if the energizing current when the number of contact points is ten is 2000 A, the energizing current when the number of contact points is four is 5000 A. By assuming that the calculated value of this energizing current is I and the contact resistance value obtained above is R, the power was obtained by calculating the following based on Ohm's law: power (W)=I²*R. Furthermore, the power quantity (Ws) was calculated by multiplying the obtained power value by an energizing time of 0.0012 seconds. Based on the evaluation criteria for welding described below, the case where the power quantity was below 81 Ws was evaluated as “good”, and the case where the power quantity was 81 Ws or above was evaluated as “bad”.

As for the evaluation criteria for welding, the plate-like terminal was actually used as the male terminal, the clip terminal was used as the female terminal, one contact point was energized, and the power quantity in which the welding of the terminal may occur was confirmed by means of the following method. Silver-antimony plating with a contact resistance value of 0.1440 mΩ was used for the plating layers of the male and female terminals. At an ambient temperature of 150° C., the test was performed under the conditions of the energizing current and energizing time shown in Table 2, and the power quantity was determined by using the above formula. After energizing, the presence or absence of welding of the terminals was checked visually, the case where welding did not occur was evaluated as “good” and the case where welding occurred was evaluated as “bad”. As shown in Reference Examples 1 to 5 of Table 2, welding did not occur when the power quantity was 81 Ws or less, but as shown in Reference Examples 6 to 10, welding occurred when the power quantity is more than 81 Ws. Therefore, the evaluation criteria for welding were set as described above.

TABLE 1

| | | | Number | | | | | | | |
|---|---|---|---|---|---|---|---|---|---|---|
| | | | of | Energizing | | Contact | Energizing | | Power | |
| | Male | Female | contact | current | | resistance | time | Power | quantity | Deter- |
| | terminal | terminal | points | (A) | | (mΩ) | (s) | (W) | (Ws) | mination |
| Example 6 | Carbon | Silver- | 10 | 2000 | Before heating | 0.0697 | 0.0012 | 278.9252 | 0.3347 | Good |
| | composite | antimony | | | After heating | 0.2572 | | 1028.9243 | 1.2347 | Good |
| | silver | plating | 4 | 5000 | Before heating | 0.0697 | | 1743.2828 | 2.0919 | Good |
| | plating | | | | After heating | 0.2572 | | 6430.7771 | 7.7169 | Good |
| Example 7 | Hard carbon | | 10 | 2000 | Before heating | 0.0697 | | 463.9884 | 0.5568 | Good |
| | composite | | | | After heating | 0.2572 | | 133.5599 | 0.1603 | Good |
| | silver | | 4 | 5000 | Before heating | 0.0697 | | 2899.9272 | 3.4799 | Good |
| | plating | | | | After heating | 0.2572 | | 834.7495 | 1.0017 | Good |
| Comparative | Silver- | | 10 | 2000 | Before heating | 0.0714 | | 285.6007 | 0.3427 | Good |
| example 6 | antimony | | | | After heating | 3.5195 | | 14077.9114 | 16.8935 | Good |
| | plating | | 4 | 5000 | Before heating | 0.0714 | | 1785.0046 | 2.1420 | Good |
| | | | | | After heating | 3.5195 | | 87986.9460 | 105.5843 | Bad |

TABLE 2

| | | | Energizing | Contact | Energizing | Power | |
|---|---|---|---|---|---|---|---|
| | | | current | resistance | time | quantity | Deter- |
| | Male terminal | Female terminal | (A) | (mΩ) | (s) | (Ws) | mination |
| Reference Example 1 | Silver-antimony | Silver-antimony | 1560 | 0.1440 | 0.096 | 36.04 | Good |
| Reference Example 2 | plating | plating | 1590 | 0.1440 | 0.177 | 66.49 | Good |
| Reference Example 3 | | | 1590 | 0.1440 | 0.176 | 66.69 | Good |
| Reference Example 4 | | | 1570 | 0.1440 | 0.216 | 78.90 | Good |
| Reference Example 5 | | | 1590 | 0.1440 | 0.216 | 80.95 | Good |
| Reference Example 6 | | | 1580 | 0.1440 | 0.236 | 87.11 | Bad |
| Reference Example 7 | | | 1580 | 0.1440 | 0.252 | 93.02 | Bad |
| Reference Example S8 | | | 1600 | 0.1440 | 0.257 | 96.25 | Bad |
| Reference Example 9 | | | 1580 | 0.1440 | 0.271 | 99.83 | Bad |
| Reference Example 10 | | | 1600 | 0.1440 | 0.297 | 111.11 | Bad |

As shown in Table 1, in Example 6 and Example 7, the power quantity was less than 81 Ws in all cases, regardless of the number of contact points and whether the state was before or after heating. Meanwhile, in Comparative example 6, when the number of contact points was four, the power quantity after heating was 100 Ws or more. Therefore, when the carbon composite silver plating or hard carbon composite silver plating was used for the plating layer of the male terminal, even if the number of contact points was reduced from ten to four or even after heating, it was possible to suppress the increase in the power quantity and it was possible to prevent the terminal from being welded. That is, by reducing the number of contact points, the energizing current per contact point increases, but since the increase in the contact resistance value after heating is suppressed in the terminal plating material of the present embodiment, it is possible to suppress the increase in the power quantity, welding of the terminals is less likely to occur, and this indicates that the contact reliability is enhanced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A terminal plating material comprising:
a metallic base that contains copper or a copper alloy; and
a carbon composite silver plating layer that is disposed on the metallic base and contains either silver or a silver alloy and carbon.

2. The terminal plating material according to claim 1, wherein
after heating at 190° C. for 500 hours, when a contact load of 10 N is applied using a contact having a hemispherical protrusion part with a radius of 1 mm as a contact part, a contact resistance value is 1.0 mΩ or less.

3. The terminal plating material according to claim 1, further comprising:
an underlayer that is interposed between the metallic base and the carbon composite silver plating layer and contains metal of at least one or more selected from the group consisting of nickel, copper, and silver.

4. The terminal plating material according to claim 1, wherein
the carbon composite silver plating layer is pure silver plating that contains the carbon.

5. A terminal connection structure comprising:
a female terminal; and
a male terminal to be fitted to the female terminal, wherein
at least one of the female terminal or the male terminal includes the terminal plating material according to claim 1.

6. The terminal connection structure according to claim 5, wherein
the male terminal includes the terminal plating material, and the female terminal includes a metallic base that contains copper or a copper alloy, and a silver-antimony plating layer that is disposed on the metallic base and contains either silver or a silver alloy and antimony.

7. The terminal connection structure according to claim 5, wherein
the female terminal is a clip terminal and the male terminal is a plate-like terminal to be fitted to the clip terminal.

8. A service plug that includes the terminal connection structure according to claim 5.
